(19) United States
(12) Patent Application Publication
(10) Pub. No.: US 2025/0354652 A1
(43) Pub. Date: Nov. 20, 2025

(54) POWERED LUBRICATION SYSTEM FOR USE WITH PIPE THREADER

(71) Applicant: MILWAUKEE ELECTRIC TOOL CORPORATION, Brookfield, WI (US)

(72) Inventors: Shrey M. Turakhiya, Milwaukee, WI (US); Joseph W. Remschak, Greenfield, WI (US)

(21) Appl. No.: 19/206,812

(22) Filed: May 13, 2025

Related U.S. Application Data
(60) Provisional application No. 63/647,766, filed on May 15, 2024.
(60) Provisional application No. 63/717,953, filed on Nov. 8, 2024.

(51) Int. Cl. F16N 7/38; F16M 13/02; F16N 39/06

(52) U.S. Cl. CPC F16N 7/38; F16M 13/022; F16N 39/06

(57) ABSTRACT

A powered lubrication system includes a housing having a reservoir configured to store a lubricant, an electric motor disposed within the housing, a pump configured to be driven by the electric motor to draw the lubricant from the reservoir, a battery pack removably coupled to a battery receptacle formed on the housing, and a lubricant dispenser coupled to the housing. The lubricant dispenser is configured to receive the lubricant discharged from the pump. The powered lubrication system further includes a mount coupled to and extending from the housing. At least a portion of the mount is attachable to a pipe fitting stand upon which a pipe is supported during a threading operation to also support the powered lubrication system upon the pipe fitting stand.

### CROSS-REFERENCE TO RELATED APPLICATIONS

This application claims priority to U.S. Provisional Patent Application No. 63/717,953, filed Nov. 8, 2024, and U.S. Provisional Patent Application No. 63/647,766, filed May 15, 2024, the entire contents of both of which are incorporated herein by reference.

### FIELD OF THE INVENTION

The present invention relates to lubrication systems, and more particularly to lubrication systems for portable pipe threaders.

### BACKGROUND OF THE INVENTION

Portable pipe threaders are typically used to cut threads into a pipe secured to a pipe stand. During a threading operation, thread-cutting dies on the portable pipe threader require lubrication to reduce friction and prevent excessive heat build-up in the pipe. Portable pipe threaders typically rely upon the operator to manually lubricate the dies with a hand-operated pump.

### SUMMARY OF THE INVENTION

The present invention provides, in one aspect, a powered lubrication system including a housing having a reservoir configured to store a lubricant, an electric motor disposed within the housing, a pump configured to be driven by the electric motor to draw the lubricant from the reservoir, a battery pack removably coupled to a battery receptacle formed on the housing, a lubricant dispenser coupled to the housing and configured to receive the lubricant discharged from the pump, and a mount coupled to and extending from the housing. At least a portion of the mount is attachable to a pipe fitting stand upon which a pipe is supported during a threading operation to also support the powered lubrication system upon the pipe fitting stand.

The present invention provides, in another aspect, a powered lubrication system including a housing having a reservoir configured to store a lubricant, an electric motor disposed within the housing, a pump configured to be driven by the electric motor to draw the lubricant from the reservoir, a battery pack removably coupled to a battery receptacle formed on the housing, a lubricant dispenser coupled to the housing and configured to receive the lubricant discharged from the pump, a first filter configured to filter coarse debris from the lubricant collected during a threading operation, and a second filter coupled to the housing to enclose the reservoir. The second filter is configured to filter fine debris from the lubricant collected during the threading operation. The first filter is coupled to the second filter to thereby filter the lubricant prior to the lubricant reaching the second filter.

The present invention provides, in another aspect, a lubrication system including a housing having a reservoir configured to store a lubricant, a pump configured to draw the lubricant from the reservoir, a lubricant dispenser coupled to the housing and configured to receive the lubricant discharged from the pump, and a mount coupled to and extending from the housing. At least a portion of the mount being removably attachable to a pipe fitting stand upon which a pipe is supported during a threading operation to also support the lubrication system upon the pipe fitting stand.

### BRIEF DESCRIPTION OF THE DRAWINGS

FIG. 1 is a perspective view of a portable pipe threader for use with a powered lubrication system of the present invention.

FIG. 2 is a perspective view of a powered lubrication system.

FIG. 3 is another perspective view of the powered lubrication system of FIG. 2.

FIG. 4 is a top view of the powered lubrication system of FIG. 2.

FIG. 5 is a bottom perspective view of the powered lubrication system of FIG. 2.

FIG. 6 is a perspective view of the powered lubrication system of FIG. 2 with an attached battery pack.

FIG. 7 is an exploded view of the powered lubrication system of FIG. 2.

FIG. 8 is a perspective view of the powered lubrication system of FIG. 2, with a lid being removed.

FIG. 9 is a perspective view of a strainer of the powered lubrication system of FIG. 2.

FIG. 10 is a top view of the strainer of FIG. 9.

FIG. 11 is a bottom view of the strainer of FIG. 9.

FIG. 12 is a cross-sectional view of the powered lubrication system of FIG. 2.

FIG. 13A is a schematic diagram of the powered lubrication system of FIG. 2 including a no-spill reservoir disposed in a right-side up position.

FIG. 13B is a schematic of the powered lubrication system of FIG. 2, the no-spill reservoir disposed in a side-facing or upright position.

FIG. 13C is a schematic view of the powered lubrication system of FIG. 2, the no-spill reservoir disposed in an up-side down position.

FIG. 14 is a perspective view of various strainers for use with the powered lubrication system of FIG. 2.

FIG. 15 is a top view of the powered lubrication system of FIG. 2 including a pump, a motor, and a PCBA.

FIG. 16 is a perspective view of the powered lubrication system of FIG. 15.

FIG. 17 is a schematic view of the powered lubrication system of FIG. 2.

FIG. 18 is a schematic view of the powered lubrication system of FIG. 2 including a pressure regulator.

FIG. 19 is a perspective view of the powered lubrication system of FIG. 2 mounted to a pipe fitting stand.

FIG. 20 is a perspective view of the powered lubrication system of FIG. 2 with portions removed, the powered lubrication system mounted to the pipe fitting stand of FIG. 19.

FIG. 21 is an enlarged view of the powered lubrication system of FIG. 2 with portions removed, the powered lubrication system mounted to the pipe fitting stand of FIG. 19.

FIG. 22 is a perspective view of a powered lubrication system according to another embodiment, the powered lubrication system mounted to the pipe fitting stand of FIG. 19.

FIG. 23 is an enlarged view of the powered lubrication system of FIG. 22 mounted to the pipe fitting stand of FIG. 19.

FIG. 24 is a side view of a wand handle for use with the powered lubrication system of FIG. 2.

FIG. 25 is a schematic view of the powered lubrication system of FIG. 2 including a quick-disconnect system.

FIG. 26 is a perspective view of the powered lubrication system of FIG. 2 including a carry strap.

FIG. 27 is a perspective view of a powered lubrication system according to another embodiment.

FIG. 28 is another perspective view of the powered lubrication system of FIG. 27.

FIG. 29A is a top view of the powered lubrication system of FIG. 27 with portions removed.

FIG. 29B is an enlarged top view of the powered lubrication system of FIG. 27 with portions removed.

FIG. 30 is a bottom perspective view of the powered lubrication system of FIG. 27.

FIG. 31A is a side view of the powered lubrication system of FIG. 27 with portions removed.

FIG. 31B is another side view of the powered lubrication system of FIG. 27 with portions removed.

FIG. 32 is a cross-sectional view of the powered lubrication system of FIG. 27.

FIG. 33 is a perspective view of a first filter of the powered lubrication system of FIG. 27.

FIG. 34 is a perspective view of the powered lubrication system of FIG. 27 without the first filter.

FIG. 35 is a side view of a second filter of the powered lubrication system of FIG. 27 with an attached lubricant channel.

FIG. 36 is a top perspective view of the second filter of FIG. 35.

FIG. 37 is a top view of the second filter of FIG. 35.

FIG. 38 is a bottom perspective view of the second filter of FIG. 35 without the lubricant channel of FIG. 35.

FIG. 39 is a top perspective view of a housing of the powered lubrication system of FIG. 27.

FIG. 40 is a top view of the housing of FIG. 39.

FIG. 41 is a perspective view of the powered lubrication system of FIG. 27 coupled to a pipe fitting stand.

Before any embodiments of the invention are explained in detail, it is to be understood that the invention is not limited in its application to the details of construction and the arrangement of components set forth in the following description or illustrated in the following drawings. The invention is capable of other embodiments and of being practiced or of being carried out in various ways. Also, it is to be understood that the phraseology and terminology used herein is for the purpose of description and should not be regarded as limiting.

### DETAILED DESCRIPTION

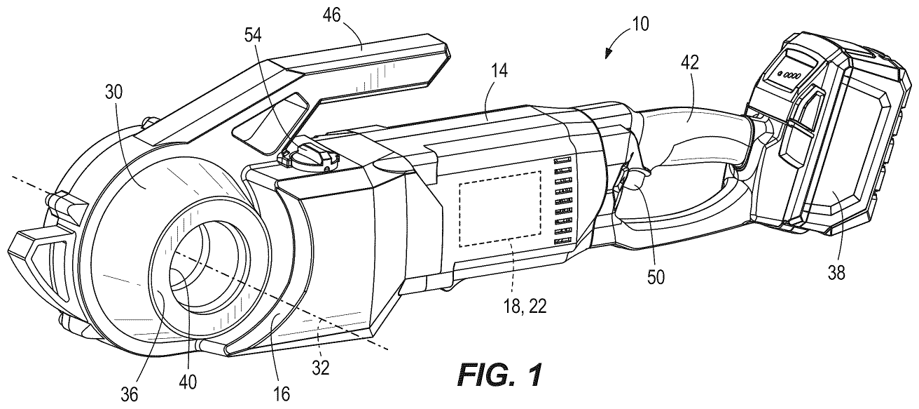

FIG. 1 illustrates a portable pipe threader 10 including a housing 14, a gear case 16, and a drive assembly 18 located in the housing 14 and gear case 16. The drive assembly 18 includes an electric motor 22 and a transmission (not shown), and the pipe threader 10 also includes a die holder 30 in which a plurality of thread-cutting dies (not shown) are received and that is driven for rotation about a rotational axis 32. The motor 22 is powered by a battery pack 38 that is attached to the housing 14 and that is interchangeably connectable to the pipe threader 10 and to a plurality of different power tools to supply power thereto. The transmission is configured to transmit torque from the motor 22 to the die holder 30, such that the die holder 30 rotates while holding the thread-cutting dies, causing the dies to cut threads on a pipe when the pipe is received within the die holder 30.

As shown schematically in the embodiment in FIG. 1, pipe threader 10 can include a non-rotating projection 36 extending from the gear case 16 around the die holder 30. The projection 36 has an annular face 40 that is concentric with the die holder 30, but in other embodiments, the projection 36 can be located elsewhere on the housing 14. In some embodiments, the non-rotating projection 36 is a thrust bearing. When the die is arranged on the pipe, the projection 36 is configured to receive a force applied by a user in a direction parallel to or coaxial with the rotational axis 32 to initiate a pipe-threading operation in response to rotation of the die. In other words, the projection 36 provides the user a stationary location relative to the housing 14 against which to push the die onto the pipe to initiate a pipe-threading operation.

With continued reference to FIG. 1, the housing 14 includes an operating handle 42 and a support handle 46 near the die holder 30. The pipe threader 10 includes a trigger 50 on the operating handle 42 for activating the motor 22 and a speed shift knob 54 allowing an operator to switch the die holder 30 (and thus the die) between a high rotational speed and a low rotational speed.

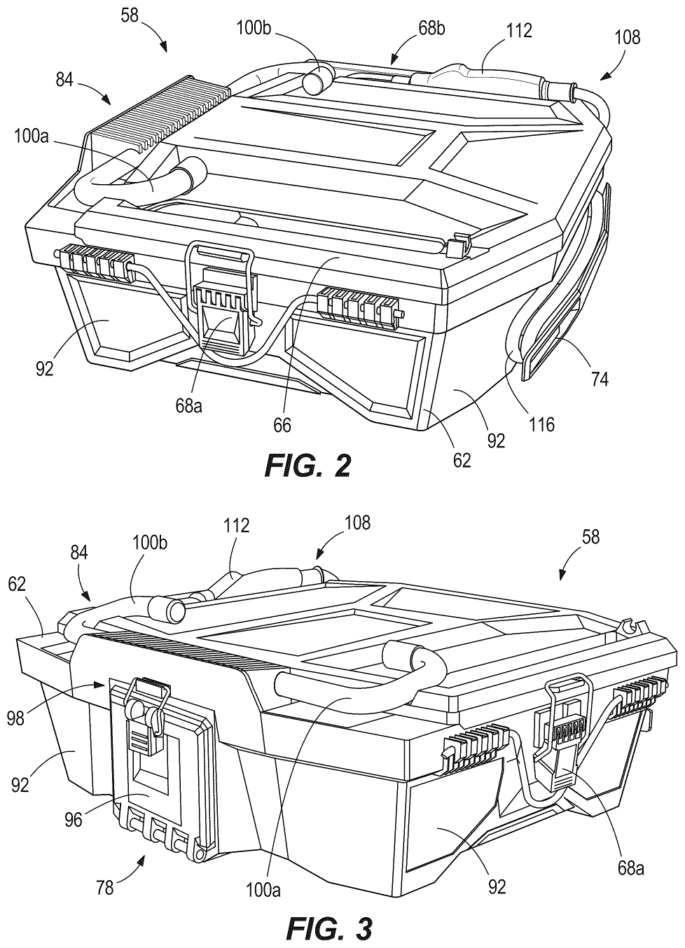

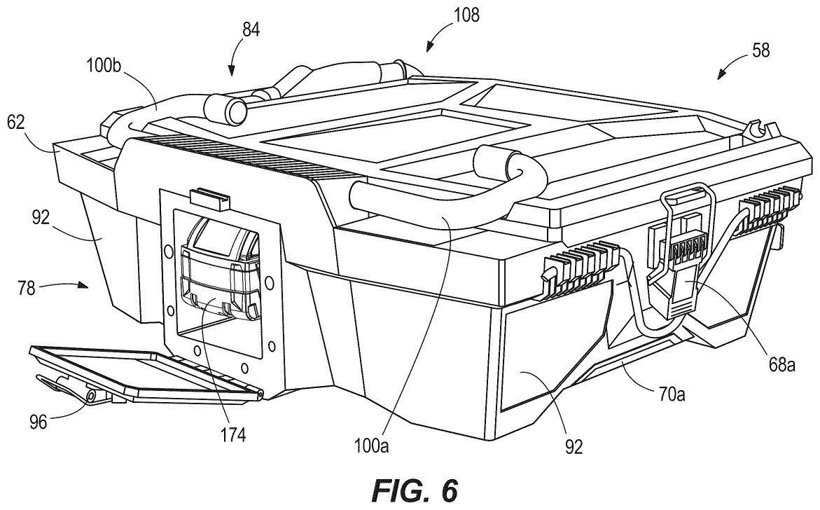

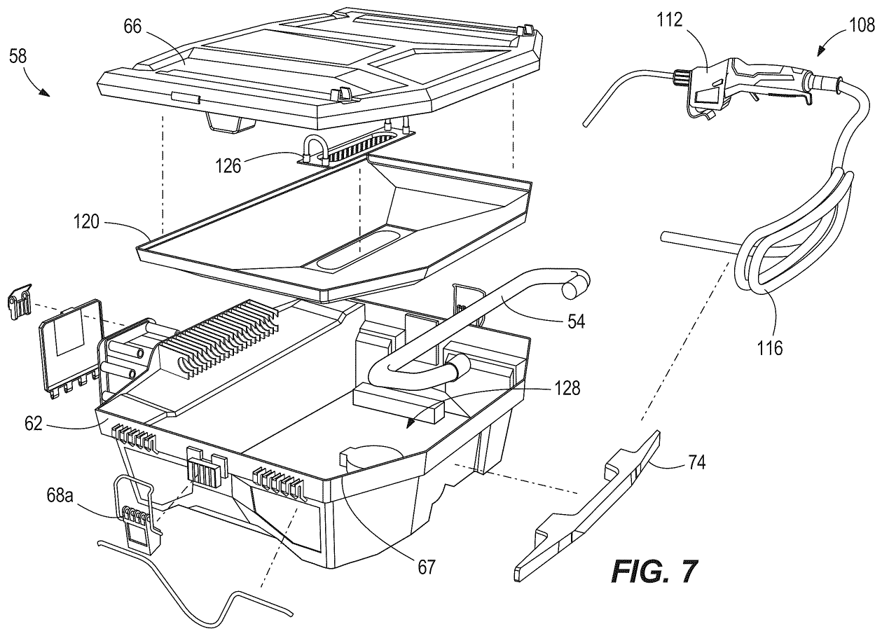

With reference to FIGS. 2-6, a powered lubrication system 58 is illustrated. The lubrication system 58 is independent of the pipe threader 10 and configured to be used with the pipe threader 10 for providing a lubricant (e.g., oil) to a pipe during a threading operation. The lubrication system 58 includes a housing 62 for storing lubricant and a lid 66 removably coupled to an open end 67 of the housing 62 for closing the open end 67 (FIG. 7). First and second quick-release latches 68a, 68b are provided along the housing 62 for locking the lid 66 onto the housing 62 to seal the housing 62. The lid 66, when secured to the housing 62 to close the open end 67, prevents ingress of debris from the external environment when the lubrication system 58 is left at a work site and accidental spilling of lubricant from the housing 62. In addition, the lubrication system 58 includes a pair of handles 70a, 70b (FIG. 5), a hose wrap 74, a battery receptacle 78, a plurality of feet 80, and a mount or a stand mounting mechanism 84. The handles 70a, 70b are respectively disposed on opposite sides of the housing 62 to permit easy grasping and carrying of the lubrication system 58. In the illustrated embodiment, the handles 70a, 70b are provided along a bottom surface 88 of the housing 62 (FIG. 5). In other embodiments, the handles 70a, 70b may be provided at other locations along the housing 62. The hose wrap 74 is coupled to one of the side walls 92 of the housing 62. The battery receptacle 78 is formed along another side wall 92 of the housing 62 and covered by a door 96 that is pivotably coupled to the housing 62. A quick-release latch 98 is carried on the door 96 and is configured to lock the door 96 in a closed position (shown in FIG. 3, with an open position being shown in FIG. 6) for sealing the battery receptacle 78 from the external environment of the lubrication system 58. The feet 80 are disposed along the bottom surface 88 of the housing 62 and support the lubrication system 58 upon a surface (e.g., the ground or a table).

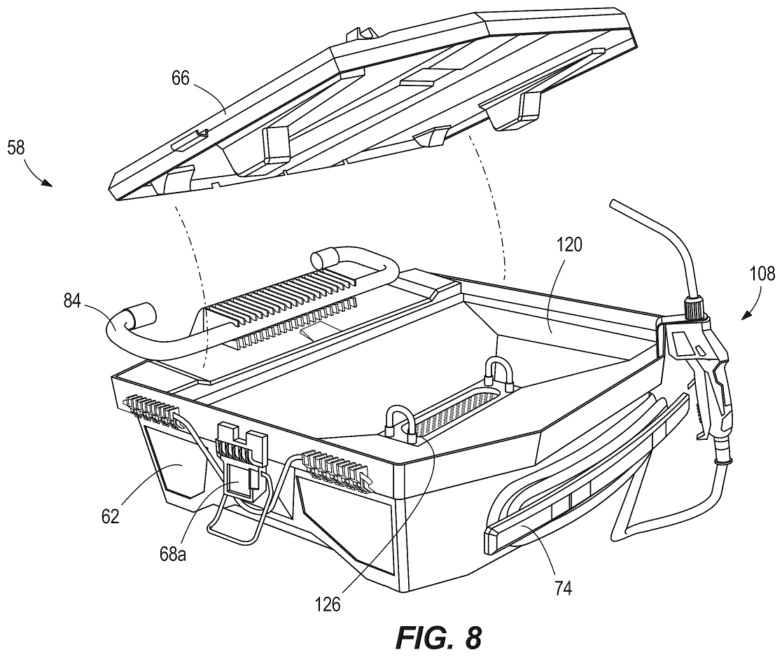

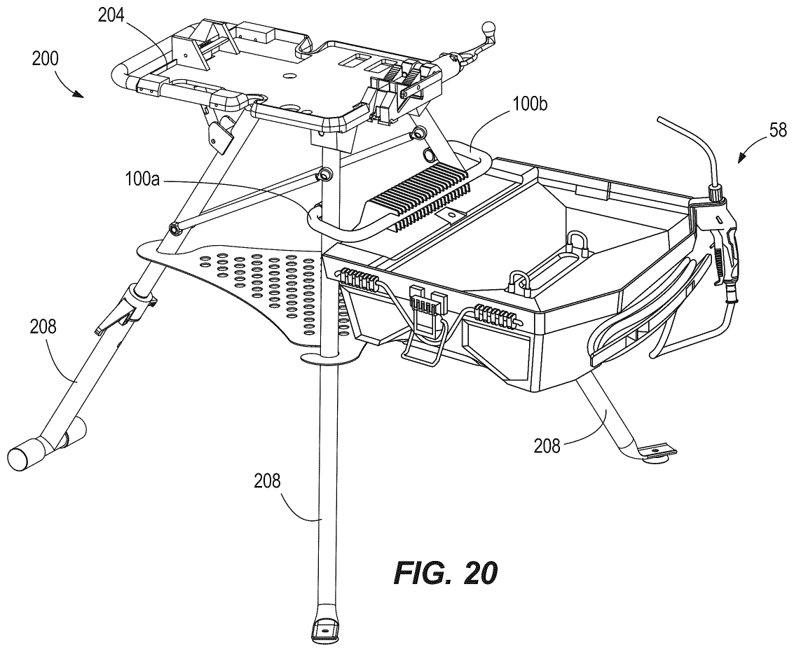

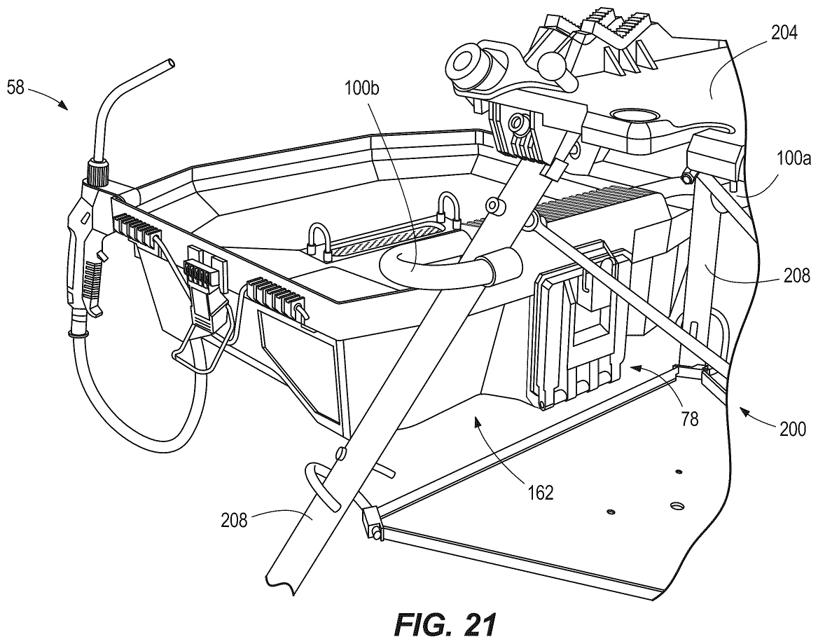

With reference to FIGS. 6-8, the stand mounting mechanism 84 has a first hook 100a and a second hook 100b that are pivotably coupled to the housing 62. More specifically, the hooks 100a, 100b are pivotable between a storage position and a mounting position. As illustrated in FIGS. 2 and 3, the hooks 100a, 100b are disposed in the storage position such that the hooks 100a, 100b are positioned along and nested with the lid 66. In the attachment position, the hooks 100a, 100b are pivoted away from the lid 66 and cantilevered from the housing 62 for attachment to a pipe fitting stand 200 (FIGS. 18-21), as discussed further in detail below.

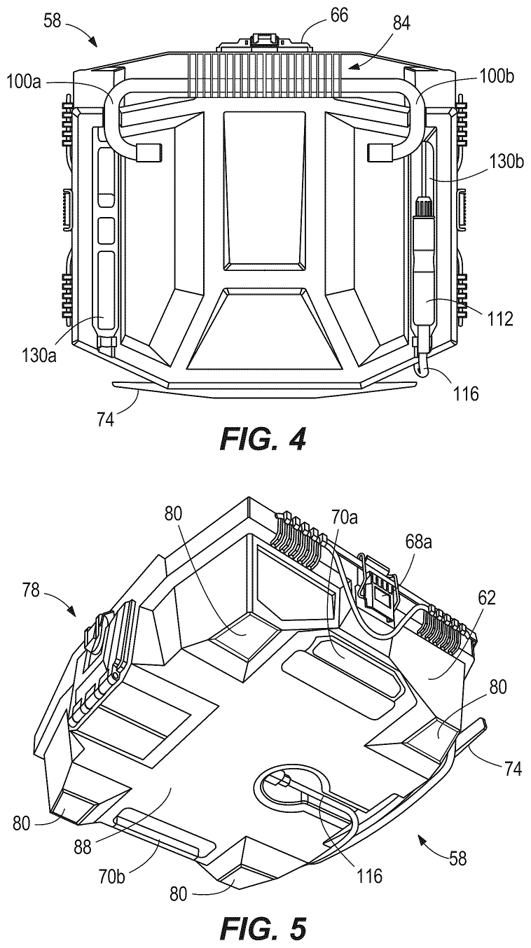

With reference to FIG. 7, the powered lubrication system 58 further includes a wand assembly 108 having a wand handle 112 and a hose 116 extending between and fluidly connecting the wand handle 112 to the housing 62. A first storage receptacle 130a and a second storage receptacle 130b are defined within the lid 66 and disposed on opposite sides of the lid 66 (FIG. 4). As such, the wand handle 112 can be stored in the first storage receptacle 130a or the second storage receptacle 130b when not being used by a user. Each storage receptacle 130a, 130b is shaped and sized to receive the wand handle 112 for storage. Also, the hose 116 may be wound around the hose wrap 74 when the wand assembly 108 is not being used. As discussed in further detail below, lubricant is dispensed from the wand assembly 108 when actuated by the user.

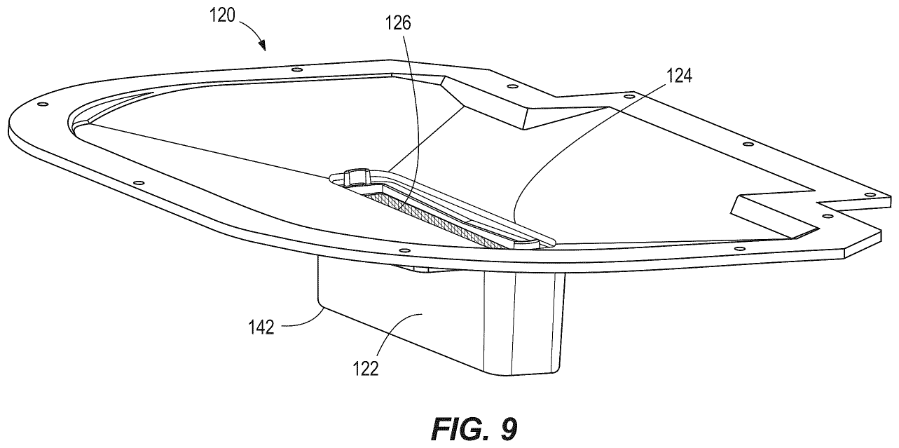

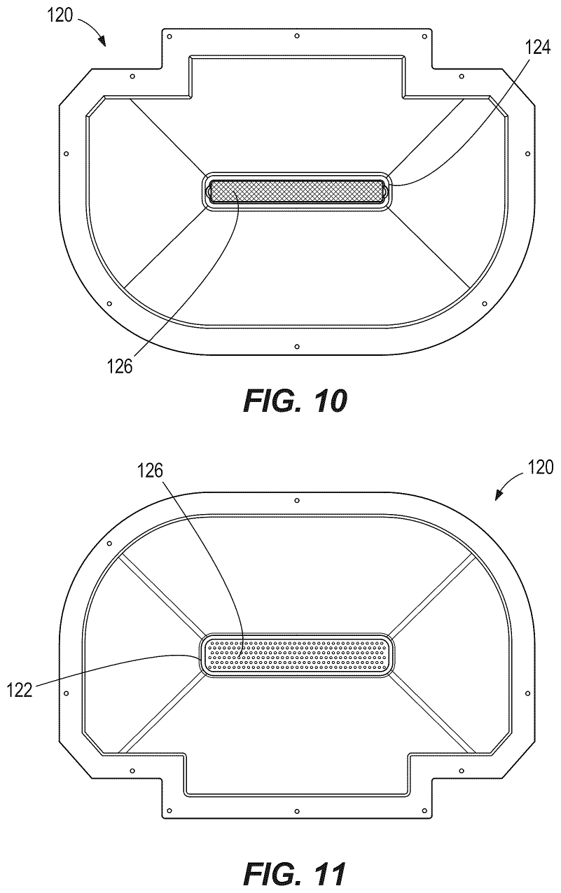

With reference to FIGS. 7-12, the lubrication system 58 also includes a catch basin or strainer 120 positioned within the housing 62. When the strainer 120 is positioned beneath the pipe during a thread-cutting operation, lubricant dispensed onto the pipe drips down into the strainer 120 along with metal shavings from the pipe. The strainer 120 is shaped as a funnel and has a stem 122 (FIG. 9) centrally located along the top surface of the strainer 120. An opening 124 is defined within the strainer 120 and extends through the stem 122. A first, coarse filter 126 is disposed within the opening 124 of the strainer 120 and sized to prevent relatively large debris from passing through the strainer 120. In the illustrated embodiment, the first filter 126 is removably coupled to the strainer 120. In other embodiments, the first filter 126 is fixed to the strainer 120.

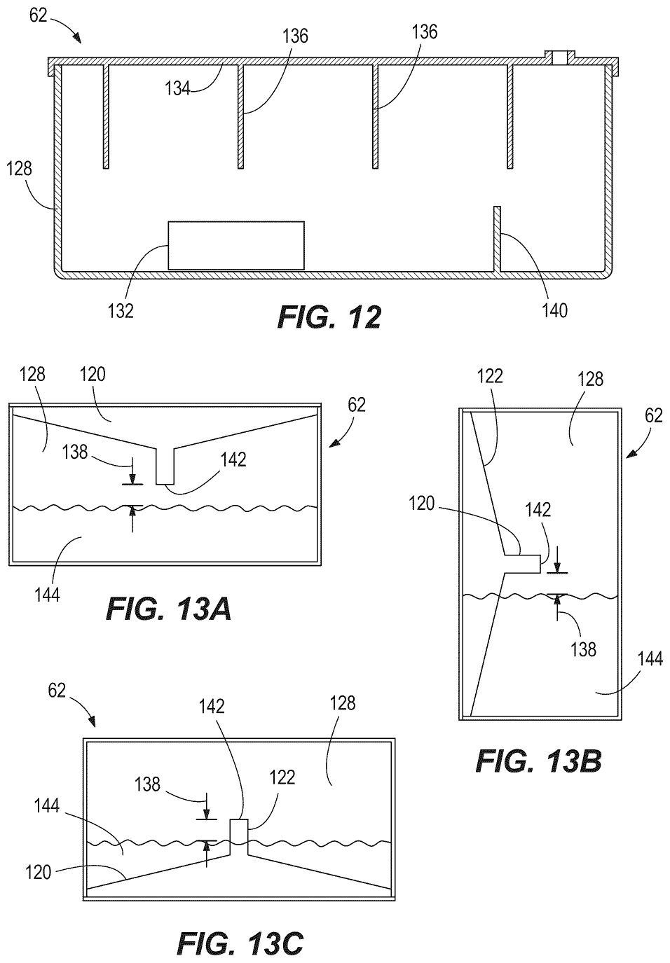

The housing 62 further includes a reservoir 128 (FIG. 7) defined therein and arranged below the strainer 120. The reservoir 128 is configured to collect and store lubricant that passes through the strainer 120 during operation and transportation of the powered lubrication system 58. An outlet 132 is defined within the reservoir 128 of the housing 62 (FIG. 12). A second, fine filter (not shown) is provided within the outlet 132 of the reservoir 128 for filtering relatively small debris from the lubricant disposed within the reservoir 128. The reservoir 128 also has multiple baffles 140 (only one of the baffles 140 is illustrated) configured to prevent excessive splashing of lubricant within the reservoir 128 during transportation of the lubrication system 58. The baffles 140 also provide a tortuous path for inhibiting debris from reaching the outlet 132 of the reservoir 128. In alternative embodiments, the housing 62 may have a cover 134 with multiple baffles 136 extending therefrom.

With reference to FIG. 13A, the housing 62 of the lubrication system 58 is shown in a right-side up position. The strainer 120 is arranged such that a substantial gap 138 (i.e., clearance) is provided between an end 142 of the stem 122 and the fluid level of lubricant 144 stored within the reservoir 128. When the lubrication system 58 is transported, the lubrication housing 62 and strainer 120 may rotate and flip, causing the fluid level of lubricant 144 to also change relative to the stem 122. The fluid level of the lubricant 144 stays below the stem 122 of the strainer 120 at any orientation of the lubrication system 58 to prevent the lubricant 144 from spilling out of the strainer 120 or housing 62. For example, when the lubrication system 58 moves between different orientations such as, the right-side up position, a side-facing or upright position (FIG. 13B), and an upside-down position (FIG. 13C), the gap 138 between the stem 122 and the fluid level of lubricant 144 is maintained to contain the lubricant 144 within the reservoir 128 and prevent spilling of the lubricant through the strainer 120. Also, an O-ring (not shown) is disposed between the strainer 120 and the housing 62 to provide a seal therebetween. Therefore, the strainer 120 effectively seals the reservoir 128 to prevent spilling of the lubricant 144 when the housing 62 is reoriented between different positions, including the right-side up position, the side-facing or upright position, and the upside-down position shown in FIGS. 13A-13C.

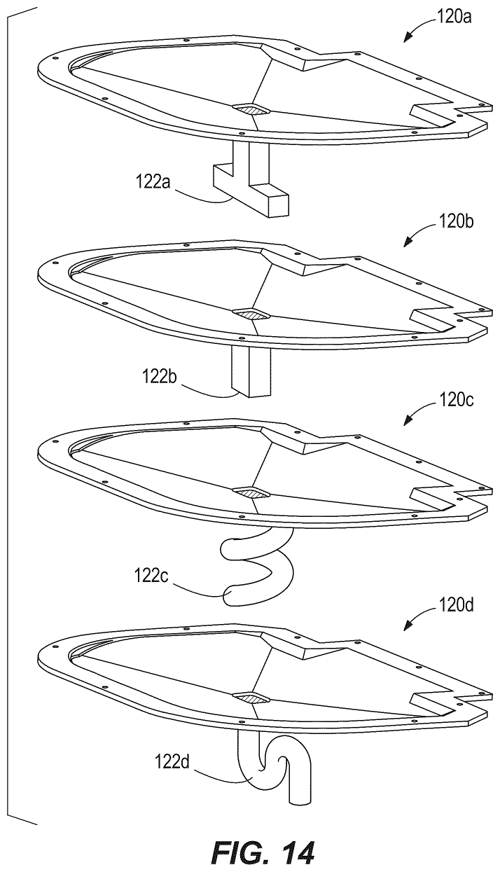

With reference to FIG. 14, various strainers 120a-d with different configurations are illustrated. A first strainer 120a has a first stem 122a that is T-shaped. A second strainer 120b, which is similar to the strainer 120 of FIGS. 9-11, has a second stem 122b with a linear configuration. A third strainer 120c has a third stem 122c with a spiral configuration. A fourth strainer 120d has a fourth stem 122d shaped as an “S” trap.

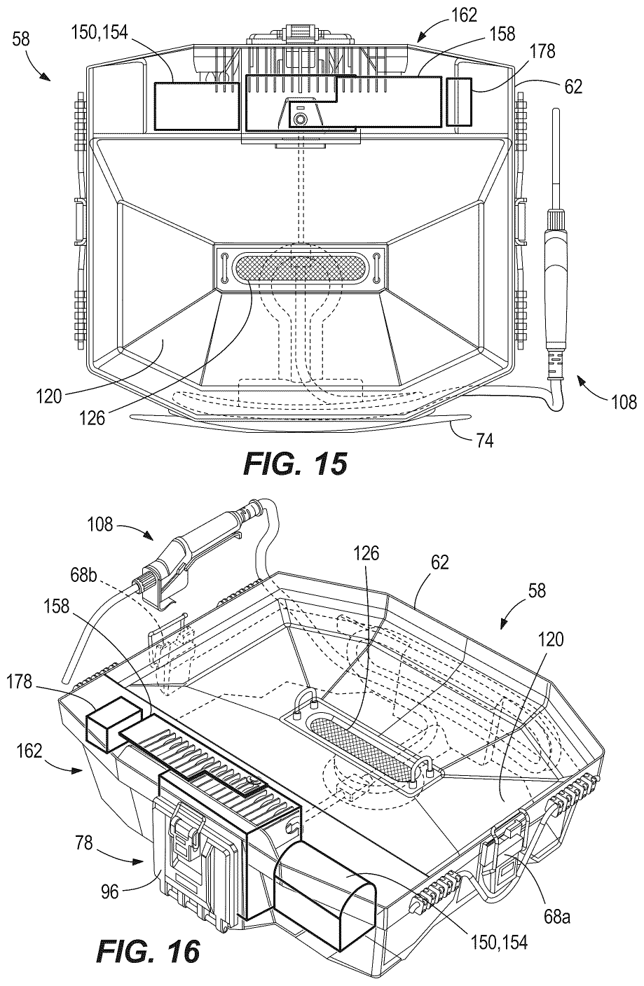

With reference to FIGS. 15-17, the lubrication system 58 also includes a pump 150, an electric motor 154 for driving the pump 150, and a printed circuit board assembly (PCBA) 158 disposed within an electronics compartment 162 defined within the housing 62. In the illustrated embodiment, the electric motor 154 is configured as a brushed electric motor. In other embodiments, the electric motor 154 may be a brushless electric motor. The electronics compartment 162 is fluidly isolated from the reservoir 128 to prevent exposure of the PCBA 158 to the lubricant. An outlet 166 of the pump 150 is fluidly connected to the wand assembly 108, while an inlet 170 (not shown) of the pump 150 is in fluid communication with the reservoir 128 (via the outlet 132 of the reservoir 128) to draw lubrication therefrom. The PCBA 158 is configured to control activation and deactivation of the motor 154 in response to actuation of the wand assembly 108. Moreover, the lubrication system 58 has a battery pack 174 (FIG. 6) electrically connectable to the battery receptacle 78. As such, the battery receptacle 78 electrically connects the battery pack 174 to the PCBA 158 which, in turn, supplies electrical current to the motor 154 to drive a gearbox (not shown). The gearbox is then operable to drive the pump 150 when the motor 154 is activated by the PCBA 158. In some embodiments, the PCBA 158 may include a variable speed control that is manually or automatically adjustable to vary the speed of the motor 154, and therefore the flow rate of lubricant dispensed from the pump 150, for different sized pipes used during a thread-cutting operation.

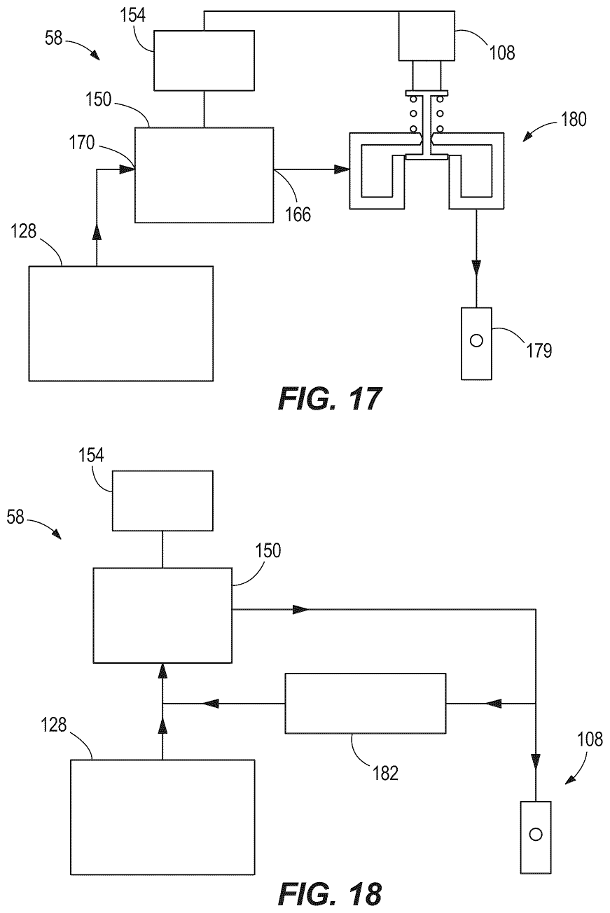

With reference to FIGS. 15 and 16, the powered lubrication system 58 also includes a pressure sensor 178 (e.g., a pressure transducer) electrically connected to the PCBA 158 and configured to detect a fluid pressure at the outlet 166 of the pump 150. Below a first predetermined detected pressure threshold, the motor 154 is activated to drive the pump 150, pressurizing lubricant drawn from the reservoir 128 and discharging the pressurized lubrication from an outlet 179 of the wand assembly 108. The pump 150 continues in the “on” state until the user releases a trigger on the wand handle 112, thereby closing an internal valve 180 (schematically shown in FIG. 17) within the wand handle 112 and stopping the flow of lubrication, causing the fluid pressure to increase at the outlet 166 of the pump 150. Once the pressure sensor 178 detects that the increasing fluid pressure reaches a second predetermined detected pressure threshold, the PCBA 158 deactivates the motor 154 and the pump 150. In response to the trigger on the wand handle 112 being depressed again, which opens the internal valve 180 again, fluid pressure at the pump outlet 166 will drop below the first predetermined detected pressure threshold (which is detected by the pressure sensor 178) and the PCBA 158 will reactivate the motor 154 to drive the pump 150 once again. In some embodiments, as illustrated in FIG. 18, instead of using the pressure sensor 178 to selectively activate the motor 154 in response to the lubricant pressure at the outlet 166 of the pump 150, the powered lubrication system 58 may alternatively include a pressure regulator 182 configured to recirculate lubricant as the motor 154 and pump 150 continuously operate when the internal valve 180 in the wand handle 112 is closed.

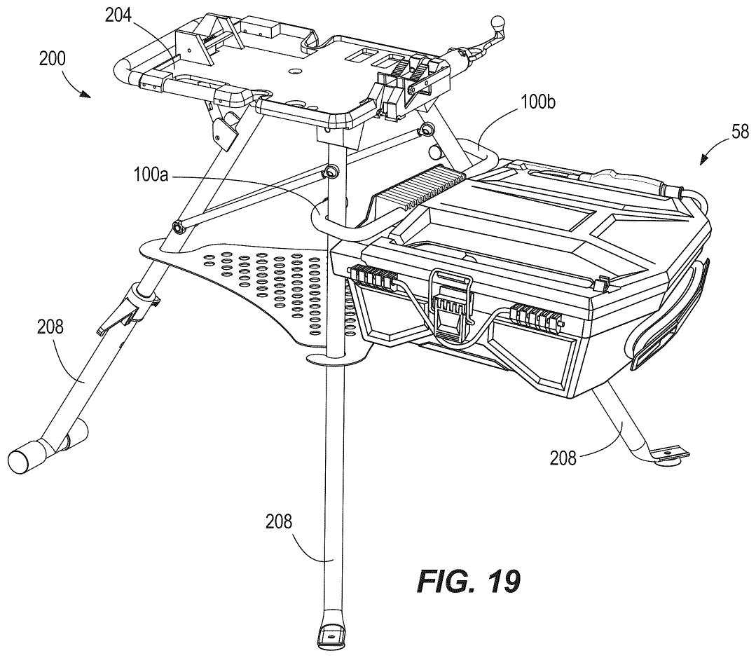

With reference to FIGS. 19-21, the powered lubrication system 58 is mounted to the pipe fitting stand 200 upon which a pipe is secured during a thread-cutting operation. The pipe fitting stand 200 includes a table 204 and a plurality of legs 208 for supporting the table 204 in an elevated position with respect to a support surface. In some embodiments, the pipe fitting stand 200 can include, in addition to features disclosed herein, some or all the features disclosed in U.S. Pat. No. 11,845,177, the entire content of which are incorporated herein by reference. In other embodiments, the pipe fitting stand 200 may be any other type of stand configured to be utilized in threading applications.

The stand mounting mechanism 84 of the lubrication system 58 is in the mounting position such that the first and second hooks 100a, 100b are accessible and coupled to the legs 208 of the pipe fitting stand 200. The respective hooks 100a, 100b are wrapped around and hooked onto a respective leg 208. As such, the stand mounting mechanism 84 supports the lubrication system 58 on the pipe fitting stand 200 such that the housing 62 is cantilevered from the pipe fitting stand 200 and beneath a pipe during a thread-cutting operation. As shown in FIGS. 19-21, the housing 62 is oriented such that the electronics compartment 162 and the battery receptacle 78 are proximate the legs 208. As such, most of the weight of the lubrication system 58 is close to the pipe fitting stand 200, reducing the likelihood that the pipe fitting stand 200 with the attached lubrication system 58 tip over. In addition, the lubrication system 58 is configured to resist a moment applied by the pipe threader 10 during a pipe-threading operation. As such, the lubrication system 58 allows the pipe threader 10 to rest against it such that the housing 62 serves as a reaction arm to the pipe threader 10 to keep it stationary during a thread-cutting operation.

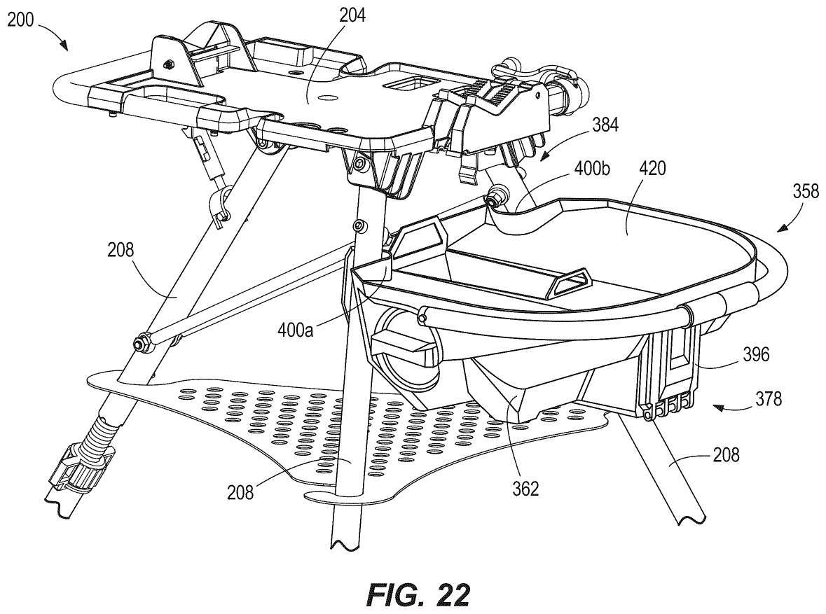

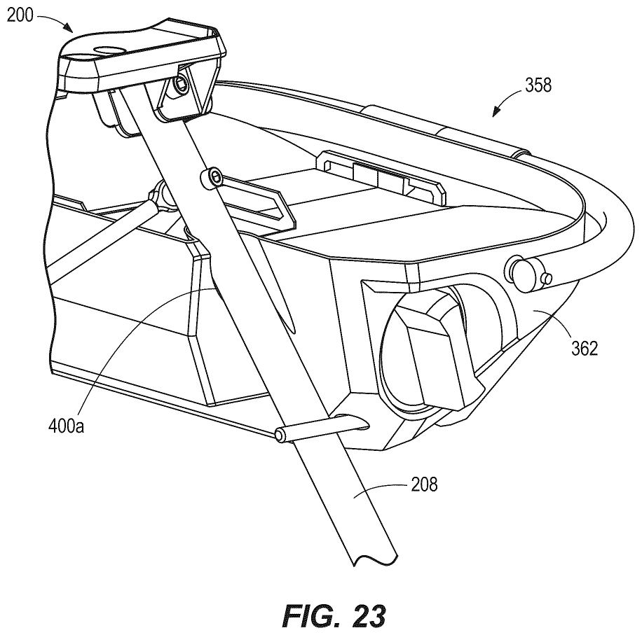

With reference to FIGS. 22 and 23, another powered lubrication system 358 is illustrated. The lubrication system 358 is similar to the lubrication system 58 of FIGS. 3-20; therefore, like structure will be identified by like reference number plus “300” and only the difference will be discussed hereafter.

The powered lubrication system 358 is coupled to the pipe fitting stand 200 of FIGS. 19-21 by a mount or a stand mounting mechanism 384 including a first groove 400a and a second groove 400b defined within a housing 362 of the lubrication system 358. Each groove 400a, 400b is configured to receive a respective leg 208 of the pipe fitting stand 200 to cantilever the housing 362 from the pipe fitting stand 200.

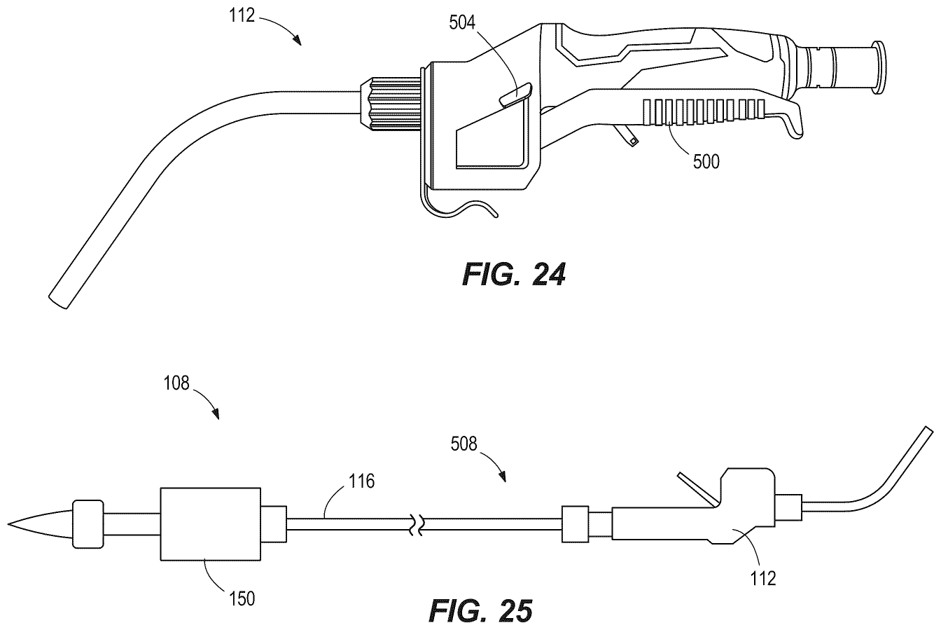

With reference to FIGS. 24 and 25, the wand handle 112 for the powered lubrication system 58 is illustrated. The wand handle 112 has a paddle trigger 500 depressible by a user for dispensing lubrication and a trigger lock 504. The wand assembly 108 further includes a quick-disconnect system 508 configured to allow the wand handle 112 and the hose 116 to be interchanged with a rigid or semi-rigid tube (not shown) for dispensing lubrication. The quick-disconnect system 508 may include one or more ball valves, multiple fittings, and the hose 116. The rigid or semi-rigid tube may be positioned by the user to locate the outlet of the tube near the pipe where the thread-cutting operation is being performed to continuously dispense lubricant to the pipe. In such an embodiment, the rigid tube may be directly coupled to the pump 150 such that the pressure sensor 178 is not needed. Since the wand handle 112 will not be provided in this embodiment, the lubrication system 58 is also provided with an ON/OFF switch (not shown) to manually activate and deactivate the motor 154.

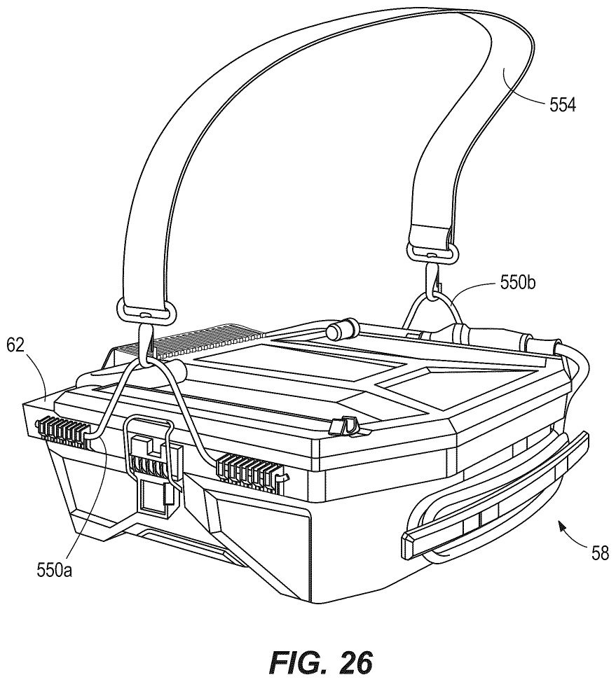

With reference to FIG. 26, the powered lubrication system 58 further includes a pair of mounts 550a, 550b pivotably coupled to opposite sides of the housing 62 and a carry strap 554 removably coupled to the mounts 550a, 550b. The carry strap 554 may be worn along a user's shoulder to support the weight of the lubrication system 58 during transportation.

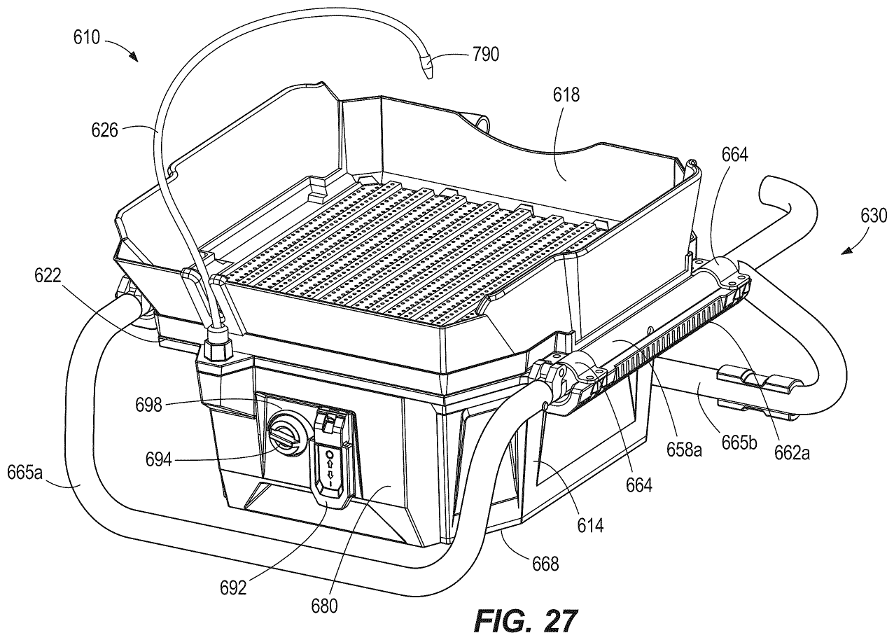

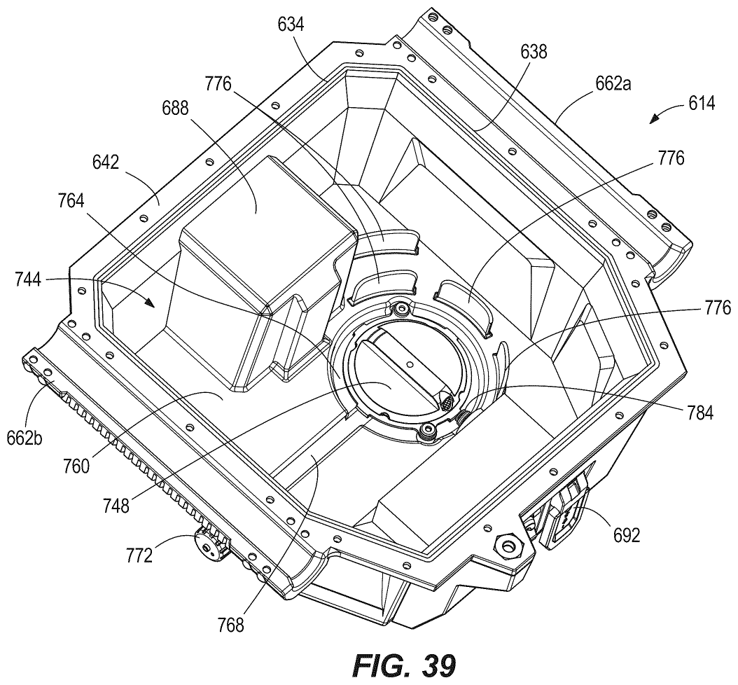

FIGS. 27-29A illustrate another powered lubrication system 610. The lubrication system 610 is independent of the pipe threader 10 of FIG. 1 and configured to be used with the pipe threader 10 for providing a lubricant (e.g., oil) to a pipe during a threading operation. The lubrication system 610 includes a housing 614 for storing lubricant, a strainer or first filter 618, a plate filter or second filter 622, a lubricant dispenser (e.g., a flexible pipe 626) for dispensing lubricant (e.g., oil), and a pipe stand mount 630. The second filter 622 is removably coupled to an open end 634 (FIG. 39) of the housing 614 for enclosing the open end 634. A groove 638 (FIG. 39) is defined along a rim 642 of the housing 614 and configured to receive a bottom periphery 646 (FIG. 38) of the second filter 622. The first filter 618 is removably coupled to the second filter 622. The second filter 622 is disposed between the housing 614 and the first filter 618 when the lubrication system 610 is fully assembled. The pipe 626 extends from the rim 642 of the housing 614 and is oriented above the first filter 618.

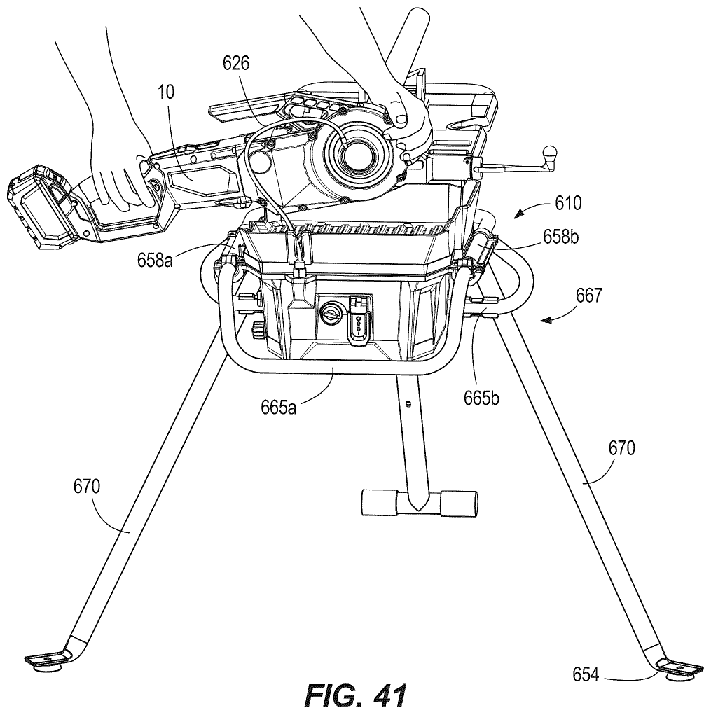

The pipe stand mount 630 is configured to engage a pipe fitting stand 654 (FIG. 41) to attach the lubrication system 610 to the pipe fitting stand 654. A first arm 658a and a second arm 658b of the pipe stand mount 630 are fixedly coupled to respective flanges 662a, 662b extending from the rim 642 of the housing 614 by brackets 664. The pipe stand mount 630 further includes a first leg 665a and a second leg 665b oriented in a horizontal direction. When the lubrication system 610 is attached to the pipe fitting stand 654, the first arm 658a and the second arm 658b hooks onto legs 670 of the pipe fitting stand 654 such that a portion of the first arm 658a and a portion of the second arm 658b wraps around the legs 670. The second leg 665b is configured to rest on and be supported by the legs 670, while the first leg 665a extends from the arms 658a, 658b to be suspended and not in contact with the pipe fitting stand 654. The first and second legs 665a, 665b hold the lubrication system 610 level such that the lubrication system 610 is oriented parallel to a floor surface 667 on which the pipe fitting stand 654 is placed. Also, when attached to the pipe fitting stand 654, the lubrication system 610 is substantially parallel to at least a portion of the pipe fitting stand 654 as the pipe fitting stand is oriented non-parallel to the floor surface 667. The pipe stand mount 630 holds the housing 614 in place, even when the housing 614 is filled with lubricant. In other embodiments, a bottom surface 668 of the housing 614 may rest on a horizontal working surface while the first and second legs 665a, 665b of the pipe stand mount 630 also rest on the horizontal working surface. As such, the bottom surface 668 and the pipe stand mount 630 are simultaneously supported by the horizontal working surface. In other embodiments, the pipe fitting stand 654 may be any other type of stand configured to be utilized in threading applications.

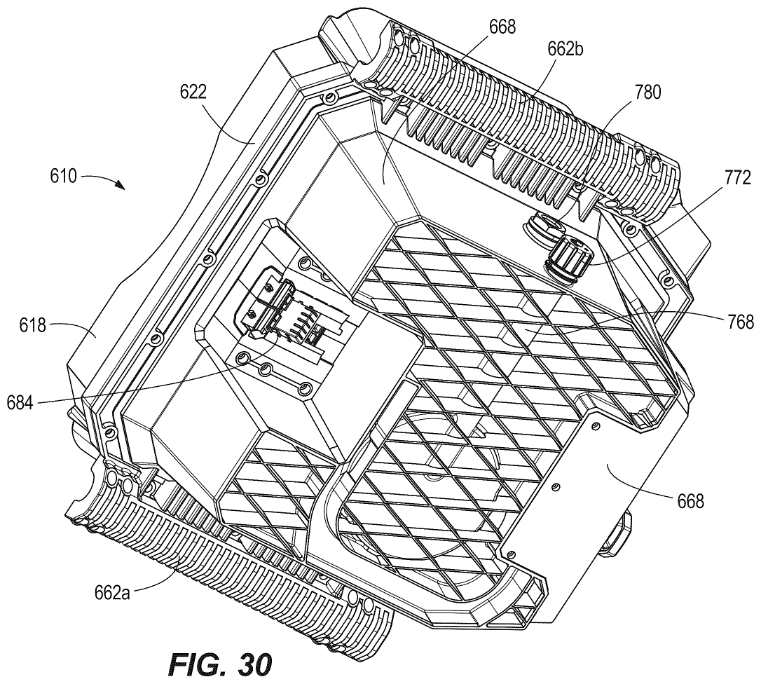

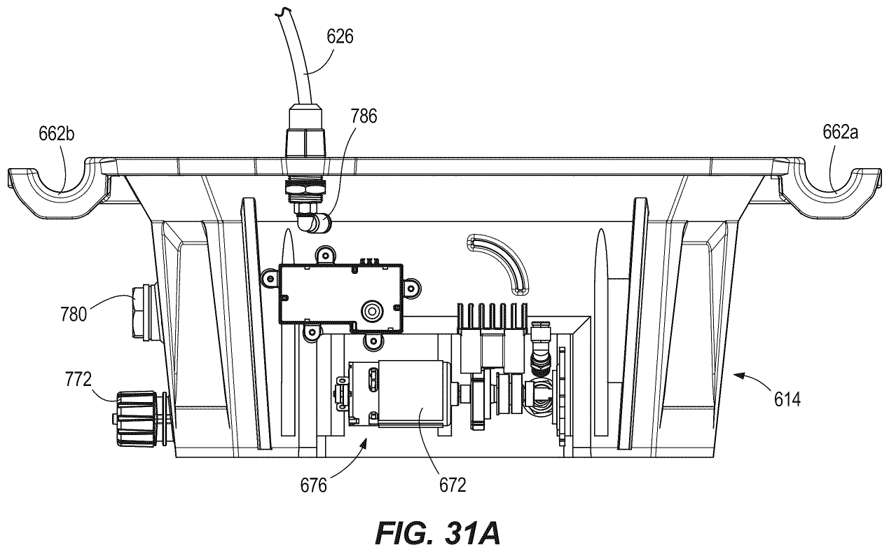

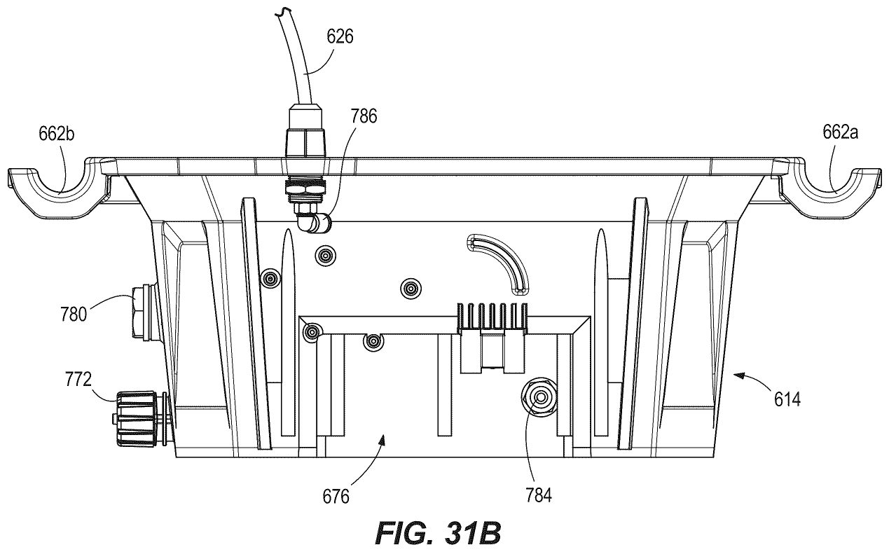

With reference to FIGS. 30 and 31A, the powered lubrication system 610 further includes an electric motor 672 disposed within a motor housing 676. The motor housing 676 is defined within the interior of the housing 614 and is enclosed by a panel 680 (FIG. 27) coupled to the housing 614 by fasteners (not shown; e.g., screws). Once the fasteners are removed, the panel 680 is removable from the housing 614 to provide access to the motor housing 676. In the illustrated embodiment, the electric motor 672 is configured as a brushed electric motor. In other embodiments, the electric motor 672 may be a brushless electric motor. Moreover, the lubrication system 610 includes a battery receptacle 684 formed on the housing 614. The battery receptacle 684 is located on an opposite side of the motor housing 676 and configured to receive a rechargeable battery pack (not shown). As such, the battery receptacle 684 electrically connects the battery pack to a printed circuit board assembly (PCBA; not shown) which, in turn, supplies electrical current to the electric motor 672 to drive a gearbox (not shown). The gearbox is then operable to drive a pump (not shown) when the motor 672 is activated. The PCBA is disposed within an electronics compartment 688 (FIG. 39).

With reference back to FIG. 27, the powered lubrication system 610 includes an actuation switch 692 and a flow rate knob 694. The actuation switch 692 is disposed on the panel 680 and configured to activate the electric motor 672 when actuated by a user. The flow rate knob 694 is also disposed on the panel 680 and adjacent the actuation switch 692. The user may rotate the flow rate knob 694 to manually adjust a flow rate of lubricant being dispensed from the pump. As such, the PCBA includes a variable speed control electrically connected to the flow rate knob 694 for adjusting the flow rate of the lubricant. A flow rate display 698, located above the flow rate knob 694, illustrates the flow rate at which lubricant is being dispensed.

With reference to FIG. 33, the first filter 618 includes a bottom surface 702 and a plurality of walls 706a-d extending upward at an oblique angle from the bottom surface 702. The first filter 618 is formed of a lightweight plastic material. To couple the first filter 618 to the second filter 622, the bottom surface 702 may be simply seated on the second filter 622. In some embodiments, the bottom surface 702 may be received within a channel defined within the second filter 622. In other embodiments, the lubrication system 610 may not be provided with the second filter 622 and the first filter 618 may be directly coupled to the housing 614 when received by a channel defined within the housing 614. Openings 710 are defined within the bottom surface 702 and distributed along the entire bottom surface 702 in the illustrated embodiment. In other embodiments, the openings 710 may be positioned along a portion of the bottom surface 702. Due to the size of the openings 710, the first filter 618 functions as a coarse filter for the lubrication system 610, preventing relatively large debris (e.g., metal chips) from passing to the second filter 622. The first filter 618 catches lubricant that is directly dispensed onto a pipe and/or pipe threader 10 and catch relatively large debris (e.g., metal chips) created during a threading operation.

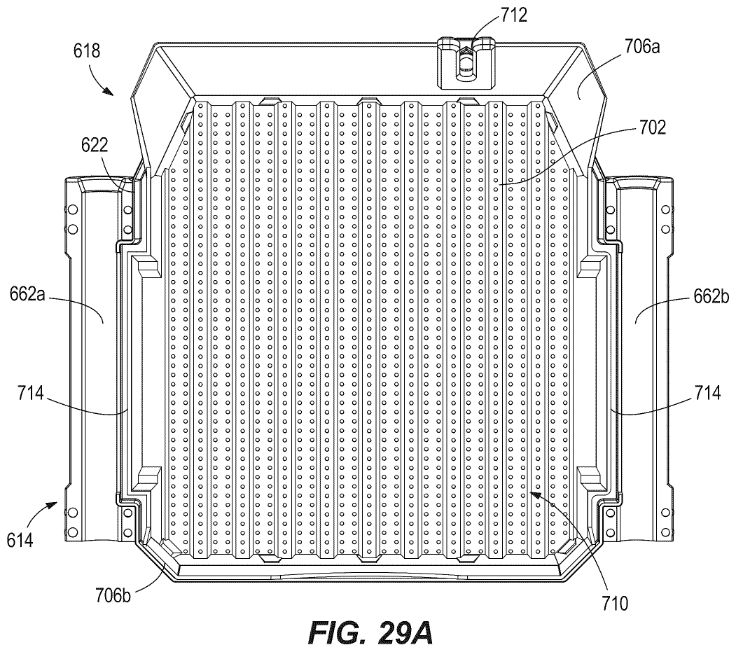

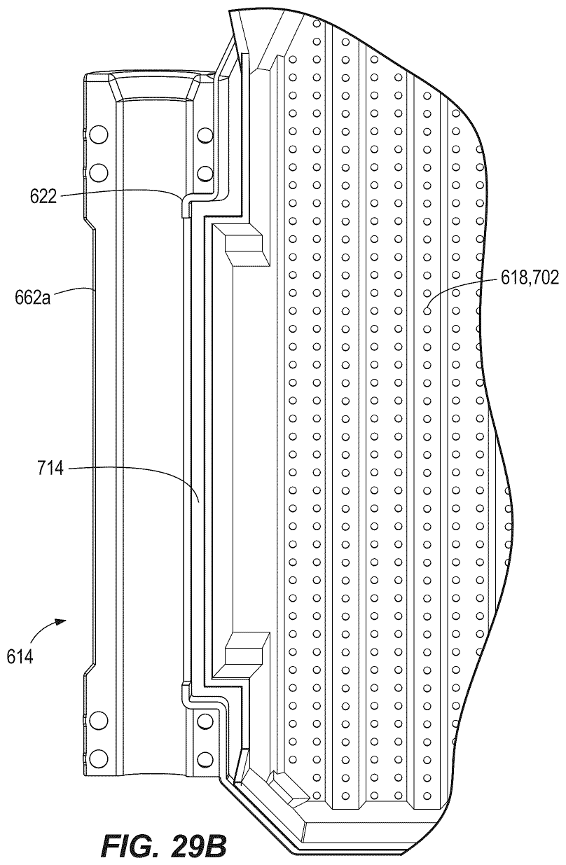

The plurality of walls 706a-d has a first wall 706a and a second wall 706b integrally formed with the bottom surface 702 and disposed opposite each other. A slot 712 is defined within the first wall 706a and configured to receive a portion of the pipe 626. Also, the plurality of walls 706a-d has a third wall 706c and a fourth wall 706d that are stiff and removably coupled to the bottom surface 702. In the illustrated embodiment, the third and fourth walls 706c, 706d are received within a channel 714 (FIGS. 29A and 29B) defined between the second filter 622 and the bottom surface 702 of the first filter 618. In some embodiments, the third and fourth walls 706c, 706d are received within a circumferential recess defined within the bottom surface 702 of the first filter 618. In other embodiments, the third and fourth walls 706c, 706d are flexible and movably coupled to the bottom surface 702 such that the walls 706c, 706d are collapsible when a user applies a pushing force. As such, the user does not need to remove the walls 706c, 706d from the bottom surface 702.

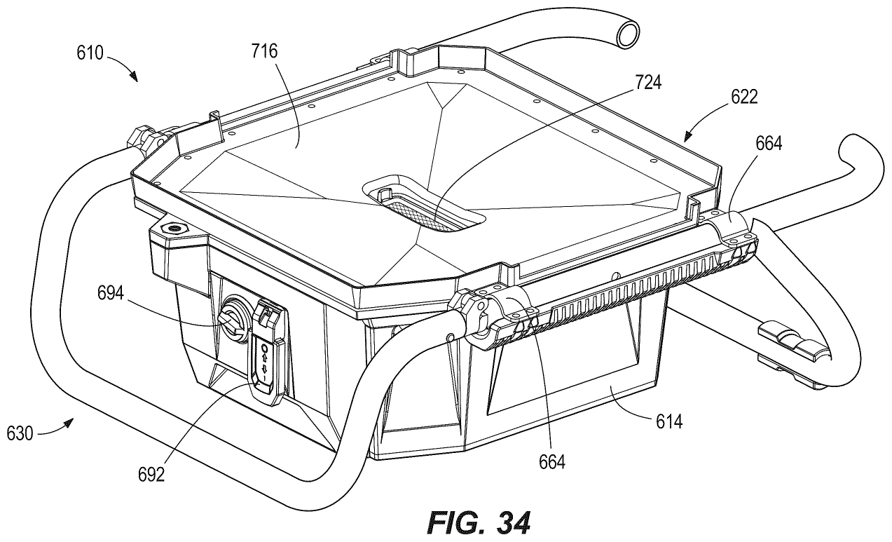

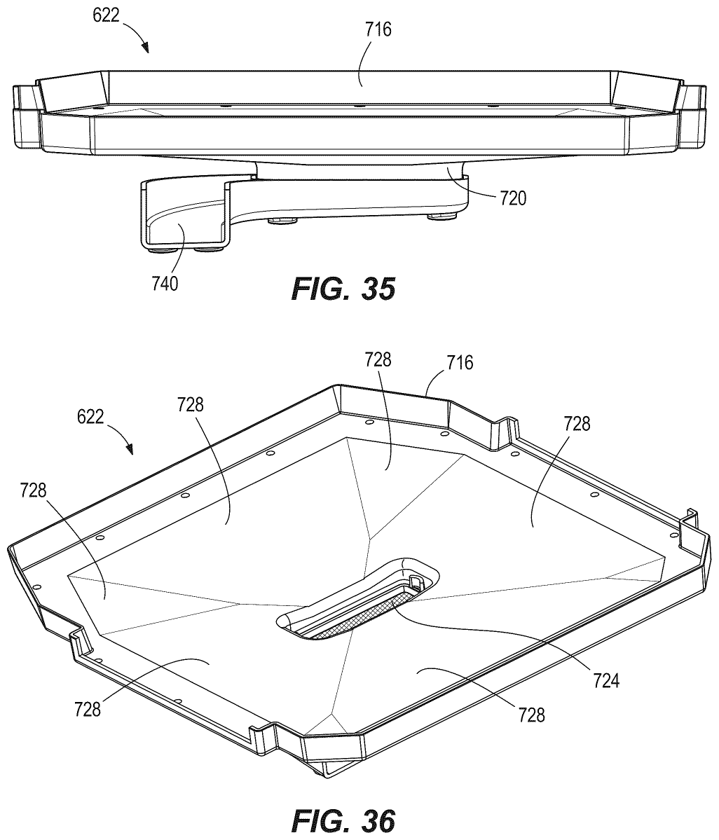

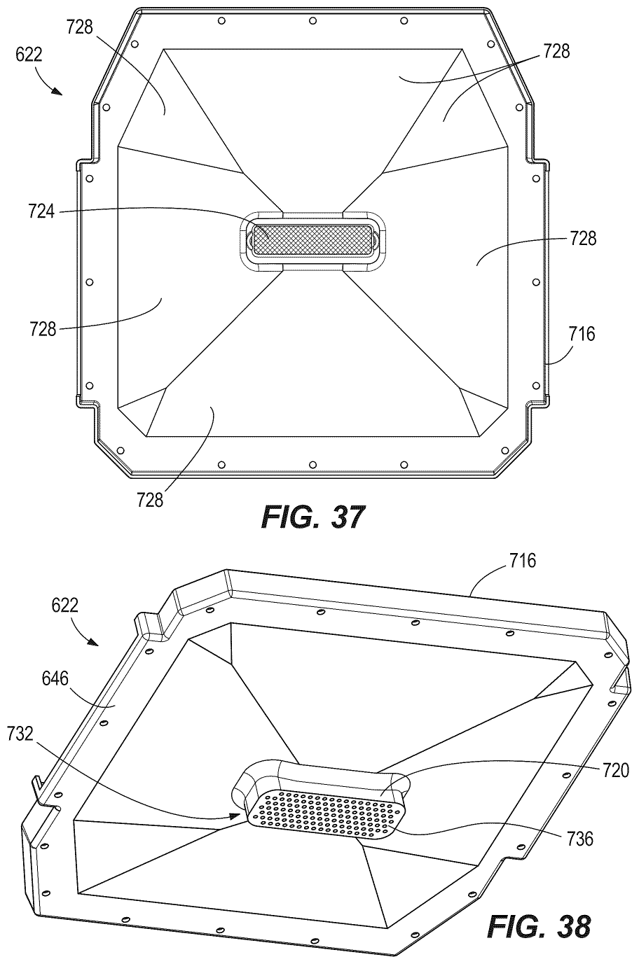

With reference to FIGS. 34-38, the first filter 618 is shown removed to expose the second filter 622. The second filter 622 includes a bottom wall 716 having a funnel 720 extending therefrom and into the housing 614. The second filter 622 is formed of the same lightweight plastic material as the first filter 618. The second filter 622 also includes a fine filter element 724 disposed within the funnel 720. The fine filter element 724 is removable from the funnel 720 so that the user may replace or clean the fine filter element 724 in between operations of the lubrication system 610. The bottom wall 716 is formed by a plurality of inclined conjoined wall segments 728 with the funnel 720 at the center of the bottom wall 716. Each wall segment 728 is inclined relative to the ground to guide the lubricant, flowing through the first filter 618, toward the center of the bottom wall 716 and the funnel 720. Once the lubricant reaches the funnel 720, the lubricant flows through the fine filter element 724. The fine filter element 724 catches relatively small debris that was not caught by the first filter 618. The lubricant then flows through openings 732 distributed throughout a bottom surface 736 of the funnel 720 and into a manifold 740 attached to the funnel 720 (FIG. 35). The manifold 740 is configured to guide lubricant into the housing 614 after the lubricant has exited the funnel 720.

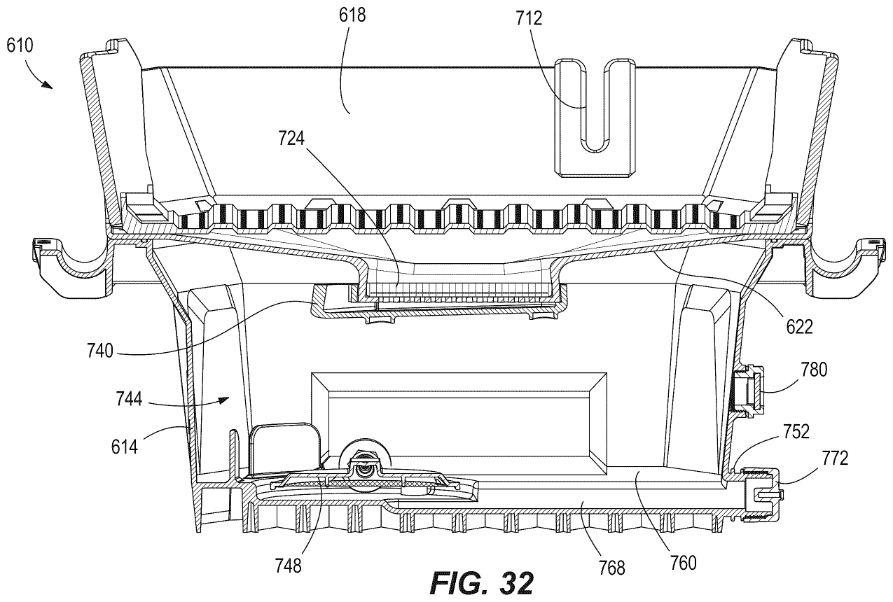

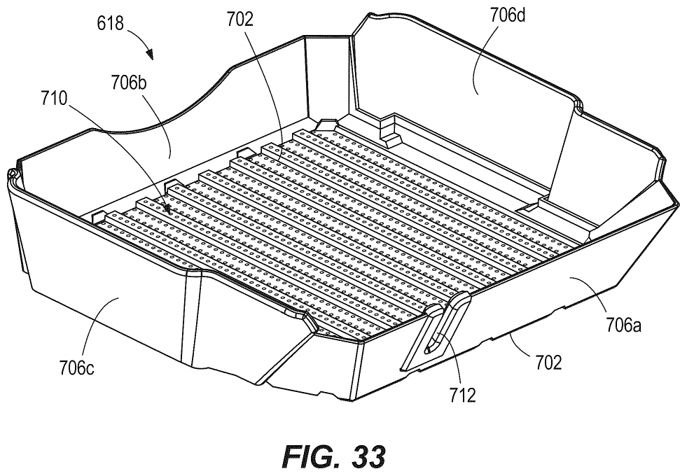

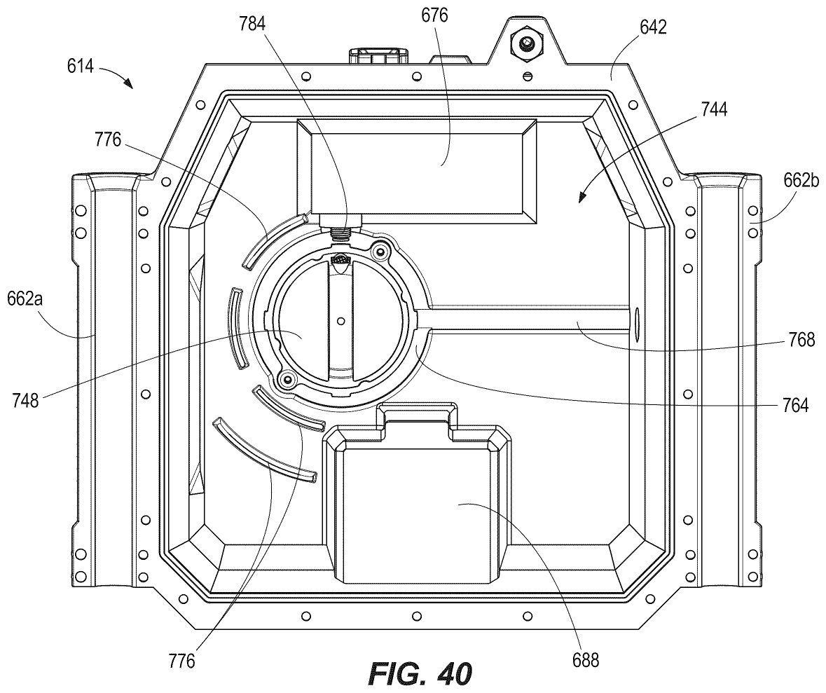

With reference to FIGS. 32, 39, and 40, the housing 614 includes a reservoir 744 defined therein and arranged below the second filter 622 when the lubrication system 610 is assembled. The reservoir 744 is configured to collect and store lubricant that passes through the second filter 622 during operation and transportation of the lubrication system 610. The housing 614 further includes a third filter 748 configured to filter lubricant that is drawn from the reservoir 744 by the pump, and a first outlet 752 (FIG. 32) defined therein and in fluid communication with the reservoir 744. The third filter 748 is another fine filter coupled to a bottom surface 760 of the reservoir 744 that at least partially defines the reservoir 744. The third filter 748 is recessed within a cavity 764 defined within the bottom surface 760 (FIG. 39). A conduit 768 is defined within the housing 614 and extends between the first outlet 752 and the cavity 764. As such, a plug 772 is provided on the first outlet 752 to seal the reservoir 744. When the plug 772 is not coupled to the first outlet 752, lubricant may be drained from the reservoir 744, and ultimately the housing 614 of the lubrication system 610.

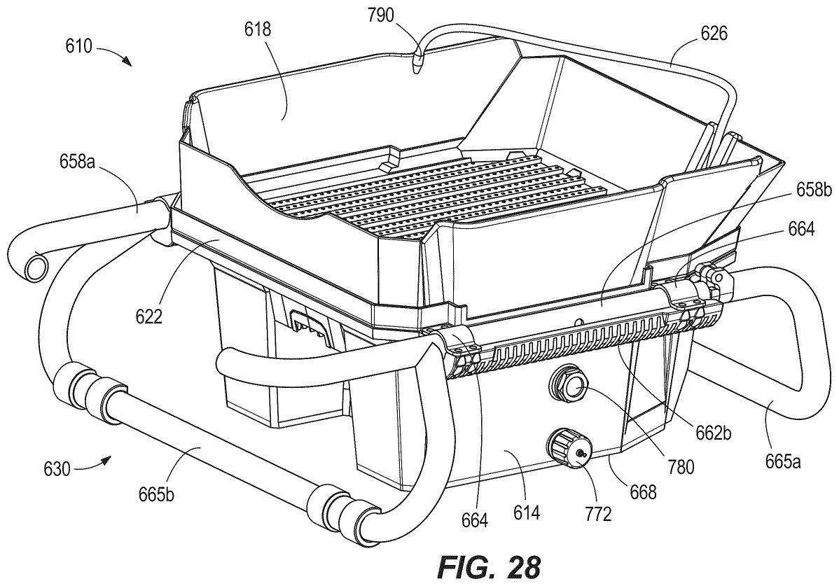

With reference to FIGS. 31B, 39, and 40, the housing 614 also includes a plurality of baffles 776 extending from the bottom surface 760 of the reservoir 744. In the illustrated embodiment, each baffle 776 has a curvilinear shape. In other embodiments, each baffle 776 may have a linear shape. The baffles 776 are configured to prevent excessive splashing of lubricant within the reservoir 744 during operation and transportation of the lubrication system 610. The baffles 776 also provide a tortuous path for inhibiting debris from reaching the first outlet 752. Moreover, the housing 614 includes a lubricant level window 780 (FIG. 28) disposed on the housing 614. The lubricant level window 780 is transparent to allow the user to view a level at which lubricant is disposed within the housing 614.

With reference to FIG. 31B, a second outlet 784 is defined within the housing 614. The second outlet 784 is arranged within the housing 614 such that the second outlet 784 is in fluid communication with the third filter 748 and/or the reservoir 744. A portion of the second outlet 784 extends into the motor housing 676 to fluidly communicate with an inlet of the pump. As such, the second outlet 784 is configured to interconnect the reservoir 744 with the inlet of the pump, which draws the lubricant from the reservoir 744. A pipe inlet 786 of the pipe 626 is also arranged within the motor housing 676 for fluid communication with an outlet of the pump.

During operation, a user moves the actuation switch 692 to an ON position to activate the electric motor 672. The electric motor 672 drives the pump such that lubricant is drawn from the reservoir 744. As the pump draws the lubricant from the reservoir 744, the lubricant flows through the third filter 748 and to the second outlet 784. The lubricant is led to the inlet of the pump and then discharged from the pump to travel through the pipe inlet 786 to be dispensed by the pipe 626. The pipe 626 is flexible and remains in the same position after being bent by the user and does not need to be held in place by the user during operation. The pumped lubricant is dispensed from a pipe outlet 790 (FIG. 27) of the pipe 626 at the same discharge pressure as the pump.

The lubricant is dispensed onto a workpiece (e.g., pipe) and/or pipe threader 10 during the threading operation. The lubricant then drips from the workpiece and into the first filter 618 to pass through the openings 710 of the bottom surface 702. As such, the first filter 618 is configured to filter the lubricant prior to the lubricant reaching the second filter 622 and the reservoir 744. The lubricant falls onto the bottom wall 716 of the second filter 622 and is guided to the funnel 720 by the wall segments 728 of the second filter 622 to eventually pass through the fine filter element 724. After passing through the fine filter element 724, the lubricant is collected in the manifold 740 and dispensed into the reservoir 744 to be pumped through the lubrication system 610 again. The lubricant is continuously pumped through the lubrication system 610 until the user moves the actuation switch 692 to an OFF position. In some embodiments, the lubrication system 610 is operable such that the lubricant is able to continuously flow in an external environment having a temperature of about −20 degrees Celsius. As such, only one person is needed to perform a threading operation and an oiling operation when the powered lubrication system 610 is used with the pipe threader 10.

In an alternative embodiment, the lubrication system 610 is a non-powered lubrication system with a manual pump configured to draw lubricant from the reservoir 744 of the housing 614. A lubricant dispenser (e.g., the wand assembly 108 of the lubrication system 58) is coupled to the housing 614 and configured to receive lubricant discharged from the pump to thereby dispense the lubricant when actuated by a user. The pipe stand mount 630 is coupled to and extending from the housing 614 of the non-powered lubrication system 610. The pipe stand mount 630 is removably attachable to a pipe fitting stand (e.g., the pipe fitting stand 654) to be supported during a threading operation.

Although the invention has been described in detail with reference to certain preferred embodiments, variations and modifications exist within the scope and spirit of one or more independent aspects of the invention as described.

Various features of the invention are set forth in the following claims.

What is claimed is:

1. A powered lubrication system comprising:
a housing having a reservoir configured to store a lubricant;
an electric motor disposed within the housing;
a pump configured to be driven by the electric motor to draw the lubricant from the reservoir;
a battery pack removably coupled to a battery receptacle formed on the housing;
a lubricant dispenser coupled to the housing and configured to receive the lubricant discharged from the pump; and
a mount coupled to and extending from the housing, at least a portion of the mount being attachable to a pipe fitting stand upon which a pipe is supported during a threading operation to also support the powered lubrication system upon the pipe fitting stand.

2. The powered lubrication system of claim 1, wherein most of a weight of the powered lubrication system is positioned close to the pipe fitting stand.

3. The powered lubrication system of claim 1, wherein the mount is coupled to the pipe fitting stand such that the housing is cantilevered from the pipe fitting stand.

4. The powered lubrication system of claim 1, wherein the mount includes a hook pivotable between a storage position and a mounting position, and wherein in the mounting position, the hook is cantilevered from the housing for attachment to the pipe fitting stand.

5. The powered lubrication system of claim 4, wherein the hook is a first hook, and wherein the mount further includes a second hook pivotable between the storage position and the mounting position.

6. The powered lubrication system of claim 4, wherein in the mounting position, the hook is wrapped around a leg of the pipe fitting stand.

7. The powered lubrication system of claim 1, wherein the mount includes a groove defined within the housing and configured to receive a leg of the pipe fitting stand.

8. The powered lubrication system of claim 1, wherein the mount includes an arm configured to hook onto at least one leg of the pipe fitting stand and a leg configured to be supported by the at least one leg of the pipe fitting stand.

9. A powered lubrication system comprising:
a housing having a reservoir configured to store a lubricant;
an electric motor disposed within the housing;
a pump configured to be driven by the electric motor to draw the lubricant from the reservoir;
a battery pack removably coupled to a battery receptacle formed on the housing;
a lubricant dispenser coupled to the housing and configured to receive the lubricant discharged from the pump;
a first filter configured to filter coarse debris from the lubricant collected during a threading operation; and
a second filter coupled to the housing to enclose the reservoir, the second filter configured to filter fine debris from the lubricant collected during the threading operation, wherein the first filter is coupled to the second filter to thereby filter the lubricant prior to the lubricant reaching the second filter.

10. The powered lubrication system of claim 9, further comprising a third filter coupled to the reservoir, the third filter configured to filter the lubricant being drawn from the reservoir by the pump.

11. The powered lubrication system of claim 9, wherein the first filter has a bottom surface with openings defined therein, a first wall integrally formed with the bottom surface, and a second wall removably coupled to the bottom surface.

12. The powered lubrication system of claim 9, wherein the second filter includes a fine filter element and a bottom wall having a funnel, and wherein the fine filter element is disposed within and removable from the funnel.

13. The powered lubrication system of claim 12, wherein the funnel is attached to a manifold configured to guide the lubricant into the housing after the lubricant has exited the funnel.

14. The powered lubrication system of claim 12, wherein the bottom wall is formed by a plurality of inclined conjoined wall segments.

15. The powered lubrication system of claim 9, wherein the housing further includes a plurality of baffles extending from a bottom surface of the reservoir.

16. A lubrication system comprising:
a housing having a reservoir configured to store a lubricant;
a pump configured to draw the lubricant from the reservoir;
a lubricant dispenser coupled to the housing and configured to receive the lubricant discharged from the pump; and
a mount coupled to and extending from the housing, at least a portion of the mount being removably attachable to a pipe fitting stand upon which a pipe is supported during a threading operation to also support the lubrication system upon the pipe fitting stand.

17. The lubrication system of claim 16, further comprising:
a first filter configured to filter coarse debris from the lubricant collected during the threading operation; and
a second filter coupled to the housing to enclose the reservoir, the second filter configured to filter fine debris from the lubricant collected during the threading operation,
wherein the first filter is removably coupled to the second filter.

18. The lubrication system of claim 17, further comprising a third filter coupled to the reservoir, the third filter configured to filter the lubricant drawn from the reservoir by the pump.

19. The lubrication system of claim 16, wherein the housing further includes an outlet defined therein and in fluid communication with the reservoir so that the lubricant may be drained from the reservoir.

20. The lubrication system of claim 19, wherein the outlet is a first outlet, and wherein the housing defines a second outlet configured to interconnect the reservoir with an inlet of the pump, which draws the lubricant from the reservoir.
